(19) United States
(12) Patent Application Publication
(10) Pub. No.: US 2007/0084929 A1
(43) Pub. Date: Apr. 19, 2007

(54) Barcode reader with a music player

(76) Inventors: Hitoshi Watanabe, Saitamai-shi (JP); Hironobu Watanabe, Koshigaya-shi (JP)

Correspondence Address: KAPLAN GILMAN GIBSON & DERNIER L.L.P., 900 ROUTE 9 NORTH, WOODBRIDGE, NJ, 07095, US

(21) Appl. No.: 11/252,310

(22) Filed: Oct. 17, 2005

(51) Int. Cl. G06K 7/10; G06K 15/00

(52) U.S. Cl. 235/462.13

(57) ABSTRACT

A portable device is provided which integrally comprises a barcode reader and a multimedia player. The multimedia player may comprise a music player, a video player, a radio receiver, a TV receiver, etc. The device preferably comprises a permanent storage such as a USB Mass Storage, and a USB connector for data transmission between the USB Mass Storage and an external unit such as a personal computer. A cap of resilient material firmly engages with the USB connector to protect the USB connector as well as to attach the device to an external item.

### BACKGROUND OF THE INVENTION

The present invention relates to a portable multifunctional device, and more particularly, to a portable barcode reader integrated with a multimedia player such as a music player.

### SUMMARY OF THE INVENTION

The object of the present invention is to provide a portable multifunctional device which can be used as both a barcode scanner and a multimedia player such as a music player.

According to the present invention, a portable device is provided which comprises both a barcode scanner and a multimedia player such as a music player. Because the scanner and the music player are integrated in a single portable device, the device brings more convenience to a user compared to the prior art where the barcode scanner and the music player are two separate devices.

Preferably, the device is provided with a permanent storage for storing information obtained from the barcode reading operations as well as digital music files.

Preferably, the permanent storage is a USB Mass Storage, and the device is provided with a USB connector secured to a body of the device for data transmission between the USB Mass Storage and an external unit such as a computer.

Preferably, a cap is provided for accommodating and holding the USB connector therein. Preferably, the cap is made of a resilient material. Preferably, the cap is connected to a ring so as to attach the device to an external item.

Preferably, the device is provided with a flat surface having a display for showing the information retrieved from the permanent storage. Preferably, the display is an LCD display. Preferably, at least a part of the flat surface can be used as a cosmetic mirror.

### BRIEF DESCRIPTION OF THE DRAWINGS

The above and other features and advantages will be clearer after reading the detailed description of the preferred embodiments of the present invention with reference to the accompanying drawings, in which:

FIG. 1 is a front view schematically illustrating an embodiment of a portable multifunctional device according to the present invention;

FIG. 2 is a back view of the embodiment in FIG. 1; and

FIG. 3 is a back view similar to FIG. 2, but with the cap separated from the USB connector.

### DETAILED DESCRIPTION OF THE INVENTION

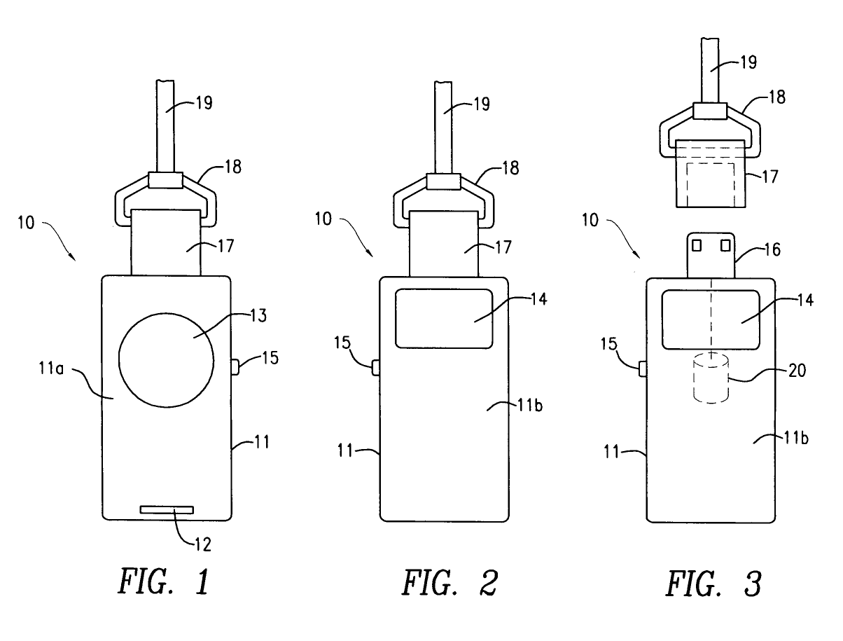

A preferred embodiment of a portable multifunctional device 10 according to the present invention is schematically illustrated in FIGS. 1-3. Functionally, the device 10 is an integral combination of a barcode scanner and a music player.

The device 10 comprises a generally rectangular body 11, which houses functional components of both the barcode reader and the music player. Since both barcode reader and music player are of conventional techniques, illustration and description of their components are largely omitted for simplification.

Preferably, as illustrated in FIG. 3, the device 10 is provided with a permanent storage 20, such as a USB Mass Storage, for storing data obtained from the barcode reading operations, digital music files, instructions, contact information, and any other information interesting to a user. Preferably, a USB connector 16 is provided for data transmission between the USB Mass Storage 20 and an external unit such as a personal computer (not shown).

As illustrated in FIG. 1, on a front surface 11a of the body 11, a slot 12 is provided for projecting a scan light beam therefrom and for receiving reflected light during barcode scan operations. Alternatively, the slot 12 may be provided in any other proper portion of the body 11.

Preferably, a rotatable button 13 is provided on the front surface 11a. The rotatable button 13 may be used to control a desired function, such as to adjust a volume of the music player, to scroll the information shown on a display 14 (to be explained more later), to search for music channels, etc. In addition to, or as an alternative to, the rotatable button 13, other functional buttons (not shown) for controlling the music player, the scanner or the whole device 10 may also be provided on the front surface 11a or other portions of the body 11. For example, a power on/off button (not shown) may be provided to turn on or turn off the power of the music player or the power of the whole device 10.

Preferably, an activation button 15 is provided at a side of the body 11 for triggering a scan operation. Alternatively, the activation button 15 may be provided at any other proper portion of the body 11.

A flat back surface 11b of the body 11 is illustrated in FIGS. 2 and 3. Preferably, the back surface 11b is provided with a display 14, which is preferably an LCD display, for showing the information stored in the storage 20.

Preferably, at least a part of the back surface 11b is properly processed so as to be usable as a cosmetic mirror as well.

Preferably, a cap 17 is provided for covering the USB connector 16 when the USB connector 16 is not in use for data transmission so as to protect the USB connector 16 from inadvertent damage. Preferably, an inner size of the cap 17 matches the size of the USB connector 16 so as to snugly accommodate the USB connector 16 therein.

Preferably, the cap 17 assumes some resiliency or is made of a resilient material such as rubber or plastic so as to firmly hold the USB connector 16 therein, and can be removed from the USB connector 16 only when a positive external force is applied thereon. Preferably, the cap 17 is connected to a ring 18 which in turn is connected to a string or a chain 19, whereby the device 10 can be attached to an external item such as the wrist of the user or a waist belt of the user.

Though the above has described the preferred embodiments of the present invention, it shall be understood that numerous adaptations, modifications and variations are possible to those skilled in the art without departing the gist of the present invention. For example, though in the preferred embodiment the device 10 has been described to include a music player, the device 10 may additionally or alternatively comprises a video player, a radio receiver and/or a TV receiver. The scanner and the player may share the same storage 20 or have their respective storages 20. Therefore, the scope of the present invention is solely intended to be defined by the accompanying claims.

1. A portable device, comprising a barcode reader and a music player.

2. The device of claim 1, further comprising a permanent storage.

3. The device of claim 2, wherein said permanent storage is adapted to store data obtained from reading barcodes by said barcode reader.

4. The device of claim 2, wherein said permanent storage is adapted to store digital music files playable by said music player.

5. The device of claim 4, wherein said music player comprises a radio receiver.

6. The device of claim 2, wherein said permanent storage comprises a USB Mass Storage.

7. The device of claim 6, wherein said USB Mass Storage comprises a flash memory.

8. The device of claim 6, further comprising a USB connector secured to a body of said device for data transmission between said USB Mass Storage and an external unit.

9. The device of claim 8, further comprising a cap forming a housing adapted to accommodate and hold said USB connector therein.

10. The device of claim 9, wherein said cap is made of a resilient material.

11. The device of claim 10, wherein said cap is made of a rubber.

12. The device of claim 10, wherein said cap is made of a plastic.

13. The device of claim 9, wherein said cap is adapted to be attached to an attachment ring so as to attach said device to an external item.

14. The device of claim 2, further comprising a body having a flat surface.

15. The device of claim 14, wherein said flat surface comprises a display for showing information obtained from said permanent storage.

16. The device of claim 15, wherein said information comprises information decoded from barcodes read by said barcode reader.

17. The device of claim 15, wherein said information comprises information of music files.

18. The device of claim 15, wherein said display is an LCD display.

19. The device of claim 14, wherein at least a part of said flat surface is adapted to be used as a cosmetic mirror.

20. A portable multifunctional device, comprises a barcode reader and a multimedia player.

21. The device of claim 20, wherein said multimedia player comprises a video player.

22. The device of claim 20, wherein said multimedia player comprises a music player.

23. The device of claim 20, wherein said multimedia player comprises a TV receiver.

24. The device of claim 20, wherein said multimedia player comprises a radio receiver.
